(19) United States
(12) Patent Application Publication
(10) Pub. No.: US 2023/0202584 A1
(43) Pub. Date: Jun. 29, 2023

(54) REINFORCING ELEMENT FOR REINFORCING A STRUCTURAL ELEMENT

(71) Applicant: SIKA TECHNOLOGY AG, Baar (CH)

(72) Inventors: Michael MEIER, Niederrohrdorf (CH); Hakim BENOUALI, Watermael-Boitsfort (BE); Denis SOUVAY, Illkirch (FR); Loic ZINGRAFF, Zurich (CH)

(73) Assignee: SIKA TECHNOLOGY AG, Baar (CH)

(21) Appl. No.: 17/923,507

(22) PCT Filed: May 7, 2021
(86) PCT No.: PCT/EP2021/062189

§ 371 Date: Nov. 4, 2022

(30) Foreign Application Priority Data
May 8, 2020 (EP) 20173730.1

(51) Int. Cl. B62D 29/04; B29C 70/52

(52) U.S. Cl. CPC B62D 29/04; B29C 70/52; B29K 2105/0097; B29K 2995/0094

(57) ABSTRACT

A reinforcing element for reinforcing a structural element in a motor vehicle includes: a carrier element which is produced by a pultrusion method and which has a longitudinal axis which, when in use, extends substantially along a longitudinal axis of the structural element, wherein the carrier element has a plurality of outer surfaces extending in the direction of the longitudinal axis; and an adhesive for bonding the carrier element to the structural element; and at least one wall, which is arranged on an outer surface; wherein the adhesive is arranged at least on the same outer surface of the carrier element as the at least one wall.

The invention relates to a reinforcing element for reinforcing a structural element in a motor vehicle.

Components, for example bodies and/or frames of transportation and conveyance means, in particular of aquatic or terrestrial vehicles or of aircraft, frequently have structures with cavities in order to make lightweight constructions possible. However, these cavities cause a wide variety of problems. Depending on the nature of the cavity, it must be sealed to prevent the ingress of moisture and dirt, which can lead to corrosion of the components. It is often also desirable to substantially reinforce such cavities, and thus the component, but to retain the low weight. Furthermore, it is also necessary in some cases to stabilize the cavities, and thus the components, in order to reduce noises which would otherwise be transmitted along or through the cavity.

For this reason, use is made in particular in automotive engineering, but also in aeronautical and marine engineering, of reinforcing elements (also “reinforcers”), among other things, in order to reinforce cavities. A known approach for producing such reinforcing elements is to injection mold a carrier in a two-component injection molding method and to injection mold an expandable adhesive as second component on an outer side of this carrier. Such reinforcing elements are inserted into cavities in structural elements, where the adhesive then expands under the action of heat and as a result adhesively bonds the carrier element to the structural element.

A disadvantage of such and similar known reinforcing elements or methods for producing reinforcing elements is that the material of the carrier can be a limiting element in the overall system in terms of the mechanical stability. However, the injection molding method mentioned above limits the choice of material for the carrier material, such that here it cannot be optimized as desired in terms of mechanical stability. Specifically in regions of crash-relevant structures, however, the mechanical stability of the system is of great importance, since as high as possible a mechanical stability is desirable for such applications.

The invention is therefore based on the object of making available an improved reinforcing element which, in particular, has improved mechanical stability. Moreover, it should be possible to produce the reinforcing element according to the invention in an efficient and cost-optimized way.

This object is achieved by a reinforcing element for reinforcing a structural element in a motor vehicle, the reinforcing element comprising: a carrier element which is produced by a pultrusion method and which has a longitudinal axis which, in a state of use, extends substantially along a longitudinal axis of the structural element, wherein the carrier element has a plurality of outer surfaces extending in the direction of the longitudinal axis; and an adhesive for bonding the carrier element to the structural element; and at least one wall, which is arranged on an outer surface; wherein the adhesive is arranged at least on the same outer surface of the carrier element as the at least one wall.

First of all, this solution has the advantage that pultruding the carrier element makes it possible to produce carrier elements with improved mechanical stability. The use of endless fibers in the direction of the longitudinal axis of the carrier element makes it possible to realize significantly more stable carrier elements.

Providing such a wall or such walls furthermore offers the advantage that the adhesive is mechanically protected as a result, before it is arranged in the structural element. For example, the risk of the adhesive being stripped or chipped off of the carrier element is thus reduced. Furthermore, such walls have the advantage that, when the adhesive is activated, expansion of the adhesive can be guided by the wall, or else, in the case of non-expandable adhesives, that its shape can be maintained.

It can be considered a further advantage that a pultrusion method requires lower tool investment costs by contrast to an injection molding method. It is thus possible, for example, to utilize a production facility for producing carrier elements with different cross sections in that it is merely necessary to adapt one shaping element for the pultrusion. By contrast to this, for the injection molding method it is necessary to produce a new respective injection mold for each different type of carrier element, resulting in high investment costs.

The solution proposed here additionally has the advantage that it makes it possible to produce the reinforcing element entirely in an uninterrupted production line. This leads to a simplification of the entire process. In the ideal case, further steps for reworking the cut-to-length reinforcing element are no longer necessary.

In one exemplary embodiment, the adhesive and the wall are arranged in the vicinity of one another.

In one exemplary embodiment, the adhesive and the wall are arranged at a distance from one another of not more than 10 mm, preferably not more than 8 mm, preferably not more than 6 mm, preferably not more than 4 mm, preferably not more than 2 mm.

In one exemplary embodiment, the adhesive and the wall are arranged adjacent to one another.

In one exemplary embodiment, the adhesive is bounded by the wall in at least one direction on the outer surface.

In one exemplary embodiment, endless fibers are used in the pultrusion of the carrier element.

In one exemplary embodiment, glass and/or carbon and/or aramid and/or natural fibers are used.

In a further exemplary embodiment, a matrix which is arranged around the fibers comprises a polyamide composition.

In a preferred development, the matrix comprises a polyamide 6.

In a further exemplary refinement, the matrix comprises a polyamide polymerized in situ.

In principle, various adhesives may be used as adhesive.

In a first exemplary embodiment, the adhesive is a shape memory material.

Such shape memory materials are described in the publication WO 2019/145503 A1, for example.

The use of a shape memory material as adhesive has the advantage that it makes it possible to arrange and prepare the adhesive in a continuous production line. It is thus possible, for example, for the adhesive applied to the carrier element to be guided through a pressing station, in which rollers transfer the adhesive into a stressed state.

In an alternative embodiment, the adhesive is a non-expandable adhesive.

In an exemplary refinement, this non-expandable adhesive expands upon activation by less than ± 20%, preferably by less than ± 10%, particularly preferably by less than ± 5%.

An exemplary commercially available material that can be used as such a non-expandable adhesive can be obtained under the trade name SikaPower®.

In a further exemplary embodiment, the adhesive is an expandable adhesive.

In an exemplary refinement, the expandable adhesive has an expansion rate of between 50% and 800%, preferably between 50% and 500%, particularly preferably between 100% and 400%.

An exemplary material that can be used as expandable adhesive can be obtained under the trade name SikaReinforcer®. An alternative material that can be used as expandable adhesive can be obtained under the trade name SikaBaffle®.

In a further exemplary embodiment, the adhesive is a non-expandable adhesive, an expandable material additionally being arranged under the adhesive.

In a preferred refinement, first of all the expandable material is arranged on the at least one outer surface of the carrier element, and then the non-expandable adhesive is arranged on the expandable material. Accordingly, lastly the expandable material is arranged between the carrier element and the non-expandable adhesive.

Such an arrangement makes it possible for the non-expandable adhesive to be pressed onto the structural element by the expandable material when it is activated, with the result that a connection can be established between the structural element and the carrier element.

As expandable material, use can be made, for example, of a material obtainable under the trade name SikaBaffle®. As non-expandable adhesive, use can be made in turn, for example, of a material obtainable under the trade name SikaPower®.

In one exemplary refinement, the carrier element comprises a different material than the wall.

In one exemplary embodiment, the wall comprises polyamide.

In one exemplary embodiment, the at least one wall is oriented substantially in the direction of the longitudinal axis.

Such an alignment of the wall has the advantage that, as a result, the wall can likewise be produced by the pultrusion method.

In one exemplary embodiment, the at least one wall is formed integrally with the carrier element.

In one exemplary embodiment, the at least one wall is produced by a pultrusion method.

In one exemplary embodiment, the at least one wall is oriented substantially transversely to the longitudinal axis.

In one exemplary embodiment, the at least one wall consists of a different material than the carrier element.

In one exemplary embodiment, the at least one wall is not produced by a pultrusion method.

In one exemplary embodiment, the reinforcing element has at least two walls, which are arranged substantially parallel to one another.

In one exemplary embodiment, the adhesive is arranged between the two walls.

In one exemplary embodiment, the adhesive is bounded by the two walls.

In one exemplary embodiment, the reinforcing element has at least two pairs of in each case two walls arranged parallel to one another, wherein the two pairs are arranged on different outer surfaces of the carrier element.

In one exemplary embodiment, the walls arranged parallel to one another are spaced apart by between 5 mm and 200 mm, preferably by between 10 mm and 150 mm, preferably by between 15 mm and 120 mm, preferably by between 20 mm and 100 mm.

In one exemplary embodiment, the at least one wall has a height of between 0.5 mm and 8 mm, preferably of between 1 mm and 6 mm, preferably of between 2 mm and 4 mm.

In one exemplary embodiment, the at least one wall has a width of between 0.5 mm and 20 mm, preferably of between 1 mm and 15 mm, preferably of between 2 and 15 mm, preferably of between 2 mm and 10 mm.

In one exemplary embodiment, the adhesive is an expandable material, wherein the at least one wall is arranged in such a way relative to the adhesive that the wall guides the adhesive during an expansion in a direction perpendicular to the outer surface of the carrier element on which the adhesive is arranged.

In one exemplary embodiment, the adhesive is a non-expandable material, wherein the at least one wall is arranged in such a way that, in a liquid state, the adhesive is guided in a predetermined direction by the wall.

In one exemplary embodiment, the at least one wall projects from the outer surface at least as high as the adhesive, thus ensuring that the adhesive is protected from mechanical effects by the wall.

In one exemplary embodiment, the at least one wall is dimensioned and arranged in such a way that the wall is in contact with the structural element in a state of use of the reinforcing element, thus enabling the reinforcing element to be positioned in a predetermined manner in the structural element with the aid of the wall.

Details and advantages of the invention will be described below on the basis of exemplary embodiments and with reference to schematic drawings, in which:

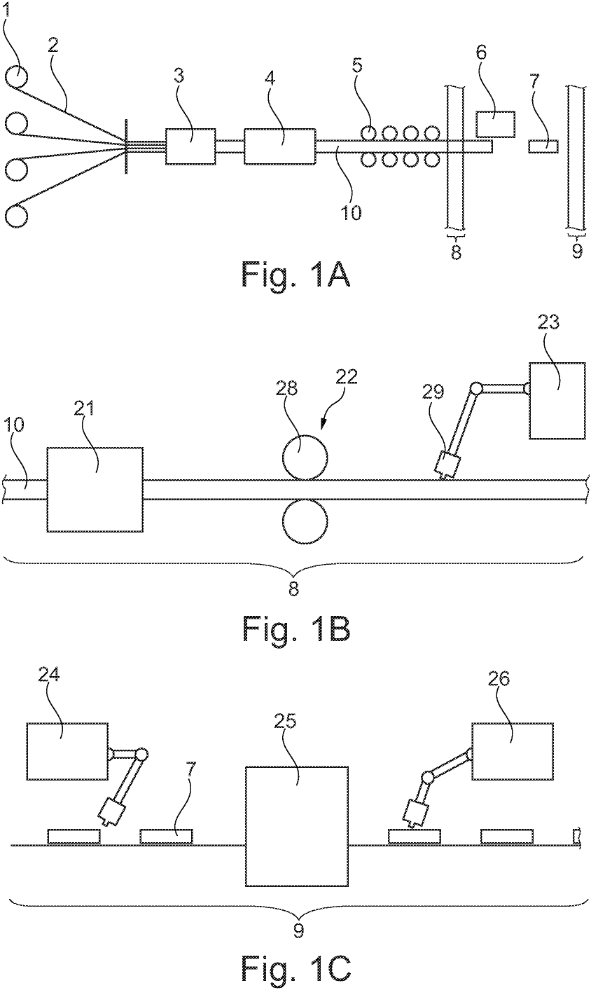

FIG. 1A shows an exemplary illustration of a pultrusion method;

FIG. 1B shows an exemplary illustration of further stations in a pultrusion production line;

FIG. 1C shows an exemplary illustration of downstream stations;

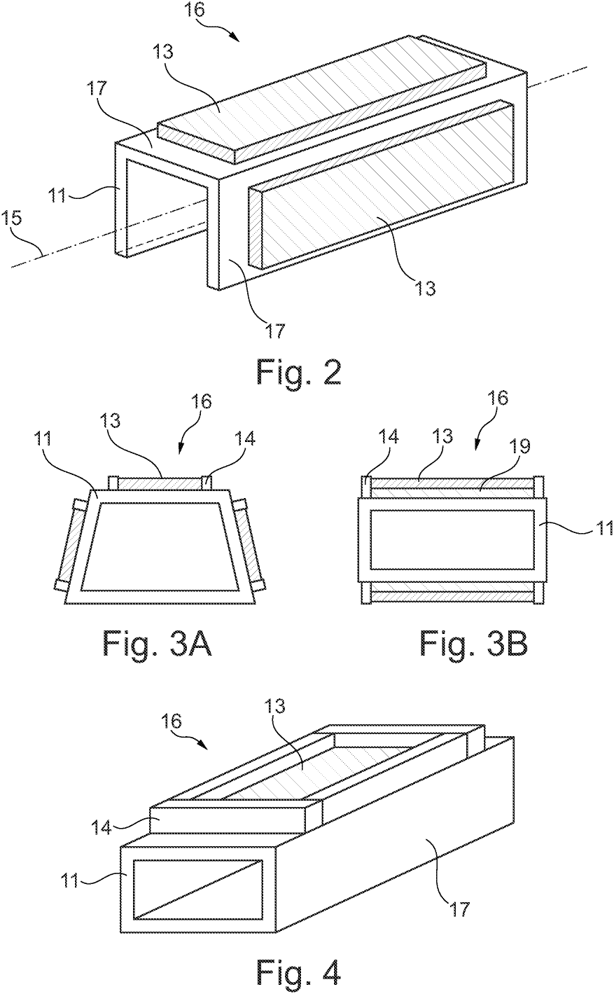

FIG. 2 shows an exemplary illustration of a reinforcing element illustrated in three dimensions;

FIGS. 3A and 3B show exemplary illustrations of cross sections through reinforcing elements;

FIG. 4 shows an exemplary illustration of a reinforcing element illustrated in three dimensions; and

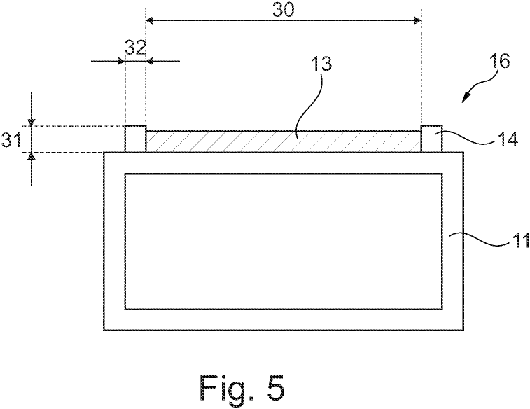

FIG. 5 shows an exemplary illustration of a cross section through a reinforcing element.

FIGS. 1A to 1C illustrate an exemplary method for producing a reinforcing element. In this respect, FIG. 1A shows an overview of such a method, and FIGS. 1B and 1C show further details of phases of this production method. In this respect, FIG. 1B schematically illustrates a phase within the production line with further stations, and FIG. 1C illustrates downstream stations that are not located in the primary production line of the pultrusion method.

According to FIG. 1A, in the course of the pultrusion, fibers 2 from fiber holding creels 1 first of all are guided through a resin tank 3. The profile 10 is then shaped and hardened in a hardening tool 4. A drawing tool 5 ensures that the fibers 2 are arranged under tension during these process steps. Accordingly, these steps result in the production of a profile 10 which serves as starting point for the carrier element. Lastly, a cutting-to-length station 6 subdivides the endlessly produced profile 10 into cut-to-length elements 7.

FIG. 1B schematically illustrates stations within the production line that are arranged in phase 8 in the overview according to FIG. 1A. In the exemplary embodiment, what is illustrated first of all is an adhesive application station 21. At this station, an adhesive is arranged onto the pultruded profile 10. In this exemplary embodiment, a shape memory material is used as adhesive. Furthermore, the adhesive is pressed by rollers 28 at a pressing station 22 and transferred into a stressed state. In addition, in this exemplary embodiment there is an extrusion station 23, from which an additional element can be extruded onto the profile 10 or the carrier element using a nozzle 29.

FIG. 1C schematically illustrates downstream stations that are arranged in phase 9 in the overview according to FIG. 1A. In this exemplary embodiment, there is a first downstream station 24, a second downstream station 25, and a third downstream station 26. What these downstream stations 24, 25, 26 have in common is that there is always a respective production step being performed there on a cut-to-length element 7 of the pultruded profile 10. For example, a first additional element can be extruded or overmolded onto the carrier element at the first downstream station 24. In the second downstream station 25, it is possible, for example, for the adhesive to be arranged on at least one outer surface of the carrier element. And in the third downstream station 26, it is possible, for example, for a second additional element to be extruded or overmolded onto the carrier element and/or onto the first additional element.

In order to produce a reinforcing element from the pultruded profile 10, it is possible, for example, for work to be done only with stations in the production line, or else work can be done only with downstream stations, or else work can be done both with stations in the production line and with downstream stations.

FIGS. 2 to 5 then illustrate, schematically and by way of example, reinforcing elements 16 that can be produced by a method according to FIGS. 1A to 1C.

FIG. 2 schematically illustrates, by way of example, a reinforcing element 16 which is not according to the invention. The reinforcing element 16 has a carrier element 11 that has a longitudinal axis 15. The carrier element 11 has multiple outer surfaces 17 extending in the direction of the longitudinal axis 15. An adhesive 13 is arranged on these outer surfaces 17. This reinforcing element 16 has no walls.

FIGS. 3A and 3B schematically illustrate cross sections through exemplary reinforcing elements 16.

FIG. 3A illustrates a reinforcing element 16 with a trapezoidal cross section. The carrier element 11 has a respective adhesive 13, laterally terminated by walls 14, arranged on three outer surfaces. Such walls 14 are therefore advantageous, because on the one hand they protect the adhesive 13 against mechanical influences, and on the other hand they can ensure expansion of the adhesive 13 or dimensional stability of the adhesive 13 when the adhesive 13 is activated.

FIG. 3B schematically illustrates a further cross section of a further exemplary reinforcing element 16. In this exemplary embodiment, the carrier 11 has a rectangular cross section. In this exemplary embodiment, an expandable material 19 and an adhesive 13 arranged thereon is arranged on the two broader outer surfaces 17 of the carrier element 11. In this respect, the expandable material 19 and the adhesive 13 are in turn laterally terminated by walls 14. When the expandable material 19 and the adhesive 13 are activated, the adhesive 13 is pressed against an inner side of the structural element by the expansion of the expandable material 19.

FIG. 4 now schematically shows a reinforcing element 16 illustrated in three dimensions. In this exemplary embodiment, the carrier element 11 has a rectangular cross section. An adhesive 13 is arranged on an outer surface 17 of the carrier element 11. In this exemplary embodiment, the adhesive 13 is delimited on all sides by walls 14.

FIG. 5 schematically illustrates a further exemplary cross section through a reinforcing element 16. In this exemplary embodiment, the carrier element 11 has a rectangular cross section. An adhesive 13 is arranged on an outer surface. A wall 14 is arranged in each case laterally with respect to this adhesive 13. These parallel walls 14 are spaced apart by a distance 30. Furthermore, the walls 14 have a height 31 and a width 32.

List of reference signs

| | |
|---|---|
| 1 | Fiber holding creel |
| 2 | Fiber |
| 3 | Resin tank |
| 4 | Hardening tool |
| 5 | Drawing tool |
| 6 | Cutting-to-length station |
| 7 | Cut-to-length element |
| 8 | Phase with stations in the production line |
| 9 | Phase with downstream stations |
| 10 | Endless profile |
| 11 | Carrier element |
| 13 | Adhesive |
| 14 | Wall |
| 15 | Longitudinal axis |
| 16 | Reinforcing element |
| 17 | Outer surface |
| 19 | Expandable material |
| 21 | Adhesive application station |
| 22 | Pressing station |
| 23 | Extrusion station |
| 24 | First downstream station |
| 25 | Second downstream station |
| 26 | Third downstream station |
| 28 | Roller |
| 29 | Nozzle |
| 30 | Distance between walls |
| 31 | Height of wall |
| 32 | Width of wall |

1. A reinforcing element for reinforcing a structural element in a motor vehicle, the reinforcing element comprising:
a carrier element which is produced by a pultrusion method and which has a longitudinal axis which, in a state of use, extends substantially along a longitudinal axis of the structural element, wherein the carrier element has a plurality of outer surfaces extending in the direction of the longitudinal axis; and
an adhesive for bonding the carrier element to the structural element; and
at least one wall, which is arranged on an outer surface;
wherein the adhesive is arranged at least on the same outer surface of the carrier element as the at least one wall.

2. The reinforcing element as claimed in claim 1, wherein the at least one wall is oriented substantially in the direction of the longitudinal axis.

3. The reinforcing element as claimed in claim 2, wherein the at least one wall is formed integrally with the carrier element, and/or wherein the at least one wall is produced by a pultrusion method.

4. The reinforcing element as claimed in claim 1, wherein the at least one wall is oriented substantially transversely to the longitudinal axis.

5. The reinforcing element as claimed in claim 4, wherein the at least one wall consists of a different material than the carrier element and/or wherein the at least one wall is not produced by a pultrusion method.

6. The reinforcing element as claimed in claim 1, wherein the reinforcing element has at least two walls, which are arranged substantially parallel to one another.

7. The reinforcing element as claimed in claim 6, wherein the adhesive is arranged between the two walls and/or wherein the adhesive is bounded by the two walls.

8. The reinforcing element as claimed in claim 1, wherein the reinforcing element has at least two pairs of in each case two walls arranged parallel to one another, wherein the two pairs are arranged on different outer surfaces of the carrier element.

9. The reinforcing element as claimed in claim 6, wherein the walls arranged parallel to one another are spaced apart by between 5 mm and 200 mm.

10. The reinforcing element as claimed in claim 1, wherein the at least one wall has a height of between 0.5 mm and 8 mm.

11. The reinforcing element as claimed in claim 1, wherein the at least one wall has a width of between 0.5 mm and 20 mm.

12. The reinforcing element as claimed in claim 1, wherein the adhesive is an expandable material, and wherein the at least one wall is arranged in such a way relative to the adhesive that the wall guides the adhesive during an expansion in a direction perpendicular to the outer surface of the carrier element on which the adhesive is arranged.

13. The reinforcing element as claimed in claim 1, wherein the adhesive is a non-expandable material, and wherein the at least one wall is arranged in such a way that, in a liquid state, the adhesive is guided in a predetermined direction by the wall.

14. The reinforcing element as claimed in claim 1, wherein the at least one wall projects from the outer surface at least as high as the adhesive, thus ensuring that the adhesive is protected from mechanical effects by the wall.

15. The reinforcing element as claimed in claim 1, wherein the at least one wall is dimensioned and arranged in such a way that the wall is in contact with the structural element in a state of use of the reinforcing element, thus enabling the reinforcing element to be positioned in a predetermined manner in the structural element with the aid of the wall.
